(19) United States
(12) Patent Application Publication
(10) Pub. No.: US 2002/0164569 A1
(43) Pub. Date: Nov. 7, 2002

(54) Paper-skull-model system

(76) Inventors: Berlalan Dudas, Szeged (HU); John D. Colombo, Washington, MI (US)

Correspondence Address: Brian S. Pickell, Bliss McGlynn & Nolan, P.C., Suite 600, 2075 West Big Beaver Road, Troy, MI, 48084, US

(21) Appl. No.: 10/140,090

(22) Filed: May 7, 2002

Related U.S. Application Data
(60) Provisional application No. 60/289,474, filed on May 7, 2001.

(51) Int. Cl. G09B 23/28

(52) U.S. Cl. 434/270; 434/262

(57) ABSTRACT

A paper-skull-model system for constructing a model of the human skull includes a plurality of elements representing various parts of the skull and adapted to be attached to each other. Each of the elements is adapted to be physically manipulated by a user of the system and has at least one marking disposed thereon. The system includes also a set of instructions to instruct the user how to physically manipulate each of the elements with respect to each marking and attach the elements together to construct the skull.

### CROSS-REFERENCE TO RELATED APPLICATION

This application claims benefit of U.S. Provisional Patent Application No. 60/289,474 that was filed on May 7, 2001 and is entitled “Paper Skull Model System.”

### BACKGROUND OF THE INVENTION

1. Field of the Invention

In general, the present invention relates to an apparatus for providing instruction about the human skull, testing or grading a person's knowledge of the human skull, displaying the human skull for purpose of comparison and/or contrast, and demonstrating characteristics of the human skull. In particular, the present invention relates to a paper model of the human skull for medical-training purposes.

2. Description of the Related Art

Artificially made parts of the human body for medical-training purposes are generally known. For instance, since the morphology of the skull is crucial in human anatomy and actual human skulls are difficult to obtain, it is known in the related art to use a simulated human skull that is adapted for demonstrating the contours, parts, and construction of a human skull and the various components thereof.

One such skull includes detachable or separable components that are adapted for assembly or separation thereof and is for use by students of anatomy, science, medicine, modeling, sculpturing, sketching, painting, etc. More specifically, the device is composed, in general, of molded synthetic-plastic material and, in particular, of one molded section that is formed with a separable skull-cap portion that may be located on and engaged with a remaining base-skull portion. A lower-jaw portion may be separably and pivotally engaged with the skull by articulating means. Access may be had to the interior of the skull and the components and contours thereof.

Other such plastic models on the market are made by a molding technique and can be obtained from Carolina Biological Supply Company (Catalog 63/1993, 24-6979 and 24-6981). These models demonstrate the smallest bony items of the human skull.

However, the known skull models suffer from the disadvantage that they cannot be used for satisfactorily studying the anatomy and composition of the skull. The known skull models suffer also from the disadvantage that they do not permit parts of the skull represented by respective pieces of the models to be assembled by hand such that the complex anatomical structure of the skull and complicated anatomical features thereof can be understood during assembly of the models. The known skull models suffer also from the disadvantage that they are not suitable for demonstrating the most difficult parts of the bones of the skull. The known skull models suffer also from the disadvantage that they are relatively expensive to manufacture and, consequently, unaffordable for many medical students, for example, and others interested in human anatomy. The known skull models suffer also from the disadvantage that the users thereof get lost during use thereof with complicated and difficult-to-understand anatomical details of the skull, and, thus, the models make learning the anatomy of the skull relatively difficult. The known skull models suffer also from the disadvantage that they are not fun and entertaining to assemble.

In medical education, a student needs a model of the human skull that is cheap to purchase and schematically well comparable to the real human skull. The student needs a model of the human skull that he or she also can easily use to understand the connections amongst the different bony items of the skull and topography of the vessels and nerves running on the surface of the skull.

Accordingly, there is a need in the related art for a skull model that can be used for satisfactorily studying the anatomy and composition of the skull. There is a need in the related art for a skull model that also permit parts of the skull represented by respective pieces of the model to be assembled by hand such that the complex anatomical structure of the skull and complicated anatomical features thereof can be understood during assembly of the model. There is a need in the related art for a skull model that also is suitable for demonstrating the most difficult parts of the bones of the skull. There is a need in the related art for a skull model that also is relatively inexpensive to manufacture and, consequently, affordable for many medical students and others interested in human anatomy. There is a need in the related art for a skull model the users of which do not get lost during use thereof with complicated and difficult-to-understand anatomical details of the skull and, thus, that makes learning the anatomy of the skull relatively easy. There is a need in the related art for a skull model that also is fun and entertaining to assemble.

### BRIEF SUMMARY OF THE INVENTION

This invention overcomes the problems in the related art in a paper-skull-model system for constructing a model of the human skull. The paper-skull-model system includes a plurality of elements representing various parts of the skull and adapted to be attached to each other. Each of the elements is adapted to be physically manipulated by a user of the system and has at least one marking disposed thereon. The system includes also a set of instructions to instruct the user how to physically manipulate each of the elements with respect to each marking and attach the elements together to construct the skull.

An advantage of the paper-skull-model system of this invention is that it provides a model of the human skull that can be used for satisfactorily studying the anatomy and composition of the skull.

Another advantage of the paper-skull-model system of this invention is that it permits parts of the skull represented by respective pieces of the model to be assembled by hand such that the complex anatomical structure of the skull and complicated anatomical features thereof can be understood during assembly of the model.

Another advantage of the paper-skull-model system of this invention is that it provides a model of the human skull that is suitable for demonstrating the most difficult parts of the bones of the skull.

Another advantage of the paper-skull-model system of this invention is that it is relatively inexpensive to manufacture and, consequently, affordable for many medical students and others interested in human anatomy.

Another advantage of the paper-skull-model system of this invention is that the users thereof do not get lost during use thereof with complicated and difficult-to-understand anatomical details of the skull, and, thus, the paper-skull-model system of this invention makes learning the anatomy of the skull relatively easy.

Another advantage of the paper-skull-model system of this invention is that it provides a model of the human skull that is fun and entertaining to assemble.

Other features, objects, and advantages of this invention will be readily appreciated as the same becomes better understood while reading the subsequent description when taken in conjunction with the accompanying figures.

### BRIEF DESCRIPTION OF THE SEVERAL VIEWS OF THE DRAWING

FIG. 1 is a perspective view of a preferred embodiment of the paper-skull-model system of the present invention in the assembled state.

FIG. 2 is another perspective view of the preferred embodiment of the paper-skull-model system of the present invention shown in FIG. 1 in the assembled state.

FIG. 3 is an elevational top view of element “I.” of the preferred embodiment of the paper-skull-model system of the present invention shown in FIG. 1 in the unassembled state.

FIG. 4 is an elevational top view of element “II.” of the preferred embodiment of the paper-skull-model system of the present invention shown in FIG. 1 in the unassembled state.

FIG. 5 is an elevational top view of elements “III.R.” and “III.L.” of the preferred embodiment of the paper-skull-model system of the present invention shown in FIG. 1 in the unassembled state.

FIG. 6 is an elevational top view of element “IV.” of the preferred embodiment of the paper-skull-model system of the present invention shown in FIG. 1 in the unassembled state.

FIG. 7 is an elevational top view of element “V.” of the preferred embodiment of the paper-skull-model system of the present invention shown in FIG. 1 in the unassembled state.

FIG. 8 is an elevational top view of elements “VI.R.” and “VI.L.” of the preferred embodiment of the paper-skull-model system of the present invention shown in FIG. 1 in the unassembled state.

FIG. 9 is an elevational top view of elements “VII.R.” and “VII.L.” of the preferred embodiment of the paper-skull-model system of the present invention shown in FIG. 1 in the unassembled state.

FIG. 10 is an elevational top view of elements “VIII.R.” and “VIII.L.” of the preferred embodiment of the paper-skull-model system of the present invention shown in FIG. 1 in the unassembled state.

FIG. 11 is an elevational top view of elements “IX.R.” and “IX.L.” of the preferred embodiment of the paper-skull-model system of the present invention shown in FIG. 1 in the unassembled state.

FIG. 12 is an elevational top view of element “X.” of the preferred embodiment of the paper-skull-model system of the present invention shown in FIG. 1 in the unassembled state.

FIG. 13 is an elevational top view of element “XI.” of the preferred embodiment of the paper-skull-model system of the present invention shown in FIG. 1 in the unassembled state.

FIG. 14 is an elevational top view of element “XII.” of the preferred embodiment of the paper-skull-model system of the present invention shown in FIG. 1 in the unassembled state.

FIG. 15 is an elevational top view of element “XIII.” of the preferred embodiment of the paper-skull-model system of the present invention shown in FIG. 1 in the unassembled state.

FIG. 16 is an elevational top view of element “XIV.” of the preferred embodiment of the paper-skull-model system of the present invention shown in FIG. 1 in the unassembled state.

FIG. 17 is an elevational top view of element “XV.” of the preferred embodiment of the paper-skull-model system of the present invention shown in FIG. 1 in the unassembled state.

FIG. 18 is an elevational top view of element “XVI.” of the preferred embodiment of the paper-skull-model system of the present invention shown in FIG. 1 in the unassembled state.

FIG. 19 is an elevational top view of elements “XVII.R.” and “XVII.L.” of the preferred embodiment of the paper-skull-model system of the present invention shown in FIG. 1 in the unassembled state.

FIG. 20 is an elevational top view of element “XVIII.” of the preferred embodiment of the paper-skull-model system of the present invention shown in FIG. 1 in the unassembled state.

FIG. 21 is an elevational top view of elements “XIX.R.” and “XIX.L.” of the preferred embodiment of the paper-skull-model system of the present invention shown in FIG. 1 in the unassembled state.

FIG. 22 is an elevational top view of element “XX.” of the preferred embodiment of the paper-skull-model system of the present invention shown in FIG. 1 in the unassembled state.

FIG. 23 is an elevational top view of element “XXI.” of the preferred embodiment of the paper-skull-model system of the present invention shown in FIG. 1 in the unassembled state.

FIG. 24 is an elevational top view of element “XXII.” of the preferred embodiment of the paper-skull-model system of the present invention shown in FIG. 1 in the unassembled state.

FIG. 25 is an elevational top view of elements “XXIII.R.” and “XXIII.L.” of the preferred embodiment of the paper-skull-model system of the present invention shown in FIG. 1 in the unassembled state.

FIG. 26 is an elevational top view of elements “XXIV.R.” and “XXIV.L.” of the preferred embodiment of the paper-skull-model system of the present invention shown in FIG. 1 in the unassembled state.

FIG. 27 is an elevational top view of elements “XXV.R.” and “XXV.L.” of the preferred embodiment of the paper-skull-model system of the present invention shown in FIG. 1 in the unassembled state.

FIG. 28 is an elevational top view of element “XXVI.” of the preferred embodiment of the paper-skull-model system of the present invention shown in FIG. 1 in the unassembled state.

FIG. 29 is an elevational top view of element “XXVII.” of the preferred embodiment of the paper-skull-model system of the present invention shown in FIG. 1 in the unassembled state.

### DETAILED DESCRIPTION OF A PREFERRED EMBODIMENT OF THE INVENTION

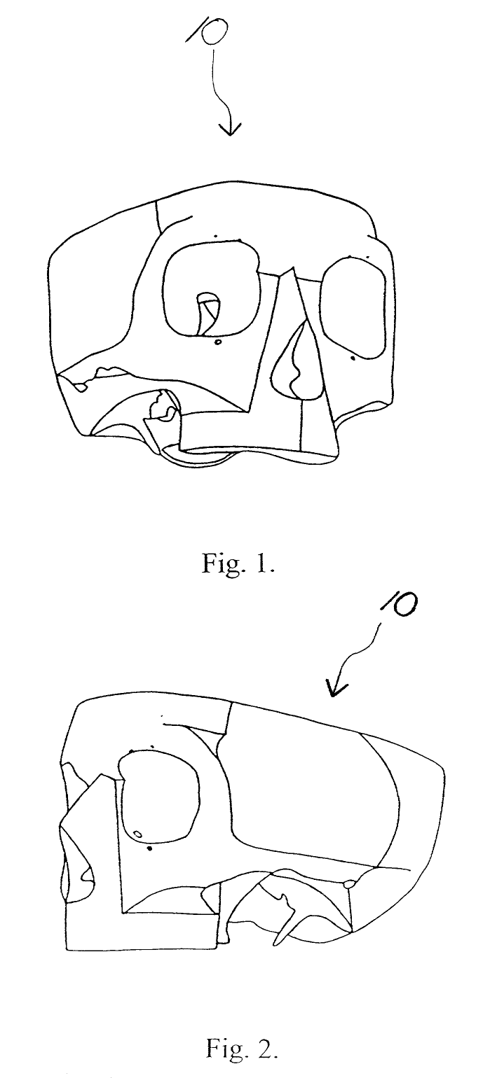

Referring now to the figures, throughout which like numerals are used to represent like structure, a paper-skull-model system of the present invention is generally indicated at 10 in FIGS. 1 and 2 in the form of an assembled anatomically correct model of the human skull. In its most basic form, the paper-skull-model system 10 includes a kit of elements and a set of instructions for assembling the elements together to construct the skull. Each element represents a different portion of the skull and includes at least one type, and often a plurality of types, of marking disposed on the element. The elements have various sizes and shapes and are adapted to be physically manipulated to conform to the requirement of a particular type of marking. Finally, the elements are attached together at various points thereof in sequential order according to the instructions, resulting in a solid, easy-to-handle model of the human skull.

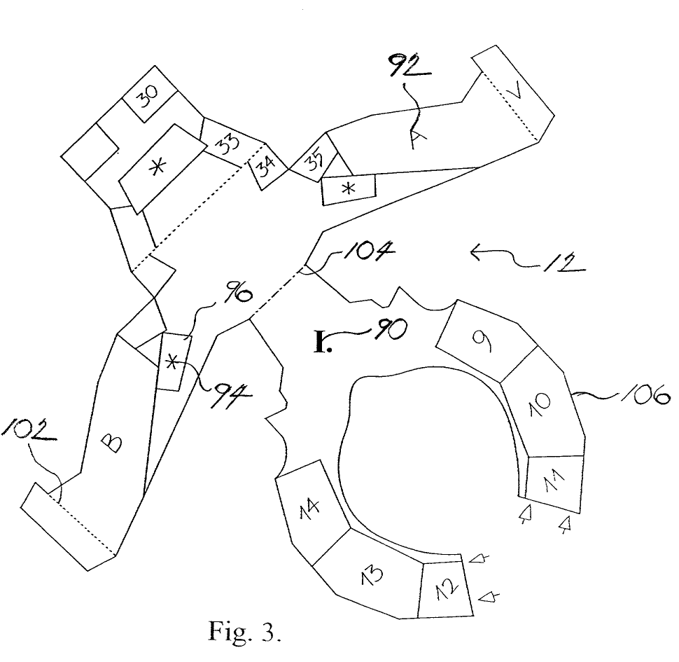

In a preferred embodiment of the paper-skull-model system 10 described in detail below and shown in the figures, the paper-skull-model system 10 includes 37 two-sided elements, generally indicated at 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84 in FIGS. 3 through 29, that are made of flat paper and scored and marked on the surface of one side thereof with markings, described in detail below. At least one element can be disposed on a sheet of plain white paper, for instance, to be cut or punched out and used to make the skull. Each element is adapted to be bent, cut, folded, and/or pierced along or through the markings, depending upon the type of marking and according to complete written instructions. Also, a point or an area of each element is adapted to be attached to an appropriate point or area of any of the other elements. The elements are then pasted together with glue also according to such instructions. Furthermore, the preferred embodiment of the paper-skull-model system 10 can include vessels and nerves running on the surface of the skull.

However, those having ordinary skill in the art will appreciate that the paper-skull-model system 10 can include any suitable number of elements that are made of any suitable material—such as cardboard, plastic, and metal—and attached to each other by any suitable means. Those having ordinary skill in the art will appreciate also that the elements can be of any suitable color, size, and shape. For instance, the elements can be manufactured with a larger size such that the paper-skull-model system 10 can be employed in a classroom-lecture setting in medical school. Those having ordinary skill in the art will appreciate also that the elements can be marked on only one or both sides thereof.

With respect to the various types of marking disposed upon an element and as shown in FIGS. 3 and 5 of the preferred embodiment of the paper-skull-model system 10, a “boldfaced font” marking 90, such as a combination of numbers and/or letters, identifies each of the different paper elements. A “normal font” marking 92, such as a combination of numbers and/or letters, identifies various surfaces of each of the elements that are to be glued to corresponding surfaces of other elements. An “asterisk” (*) marking 94 identifies an area 96 defining a window on an element to be cut therefrom. A “cross” (+) marking 98 identifies a point on an element to be pierced. A “segmented line” (---) marking 100 identifies a line to be cut. A “dotted line” (^{•••}) marking 102 identifies a folding line defining a surface on either side thereof to be folded toward the marked surface of the element. A “dotted-segmented line” (^{•}-^{•}) marking 104 identifies a folding line defining a surface on either side thereof to be folded toward the unmarked surface of the element. And, a “continuous line” (—) marking 106 identifies the border of an element.

However, those having ordinary skill in the art will appreciate that the paper-skull-model system 10 can use any suitable marking system to mark the elements. For instance, gray-shaded areas can be used to identify the windows 96 to be cut from the elements.

To prepare for assembly of the model of the skull, the paper elements are cut and folded according to the markings 90, 92, 94, 96, 98, 100, 102, 104, 106. More specifically, the “segmented line” markings 100 are cut, the windows 96 are cut out, and the “crosses” 98 are pierced. In addition, either side to a “dotted line” marking 102 is folded toward the marked surface, and either side to a “dotted-segmented line” marking 104 is folded toward the unmarked surface of the respective element. In the preferred embodiment of the paper-skull-model system 10, the “line” markings 100, 102, 104, 106 are scratched with the dull part of a knife, for example, prior to folding or cutting them.

The preferred embodiment of the paper-skull-model system 10 provides the elements and detailed instructions for assembling representations of the orbits and facial cranium, zygomatic arch, neurocranium, nasal septum and hard palate, middle and posterior cranial fossa, anterior cranial fossa, external skull base, pterygoid and styloid processes, and nasal cavity of the human skull. Of course, those having ordinary skill in the art will appreciate that more or fewer parts of the human skull can be represented by the paper-skull-model system 10.

Detailed Gluing Instructions of the Preferred Embodiment of the Paper-Skull-Model System 10

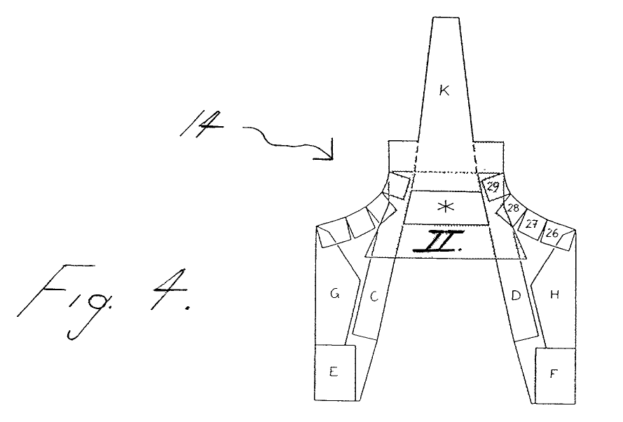

Glue the unmarked surface (shaded by streaks) of element “I.,” shown in FIG. 3 at 12, with the unmarked surface of the similarly marked element “II.,” shown in FIG. 4 at 14.

Glue the:

unmarked face of surface “A” with the marked face of surface

unmarked face of surface “C” with the marked face of surface

unmarked face of surface “E” with the marked face of surface “F” of elements “III.R.” and “III.L.,” shown in FIG. 5 at 16 and 18, respectively.

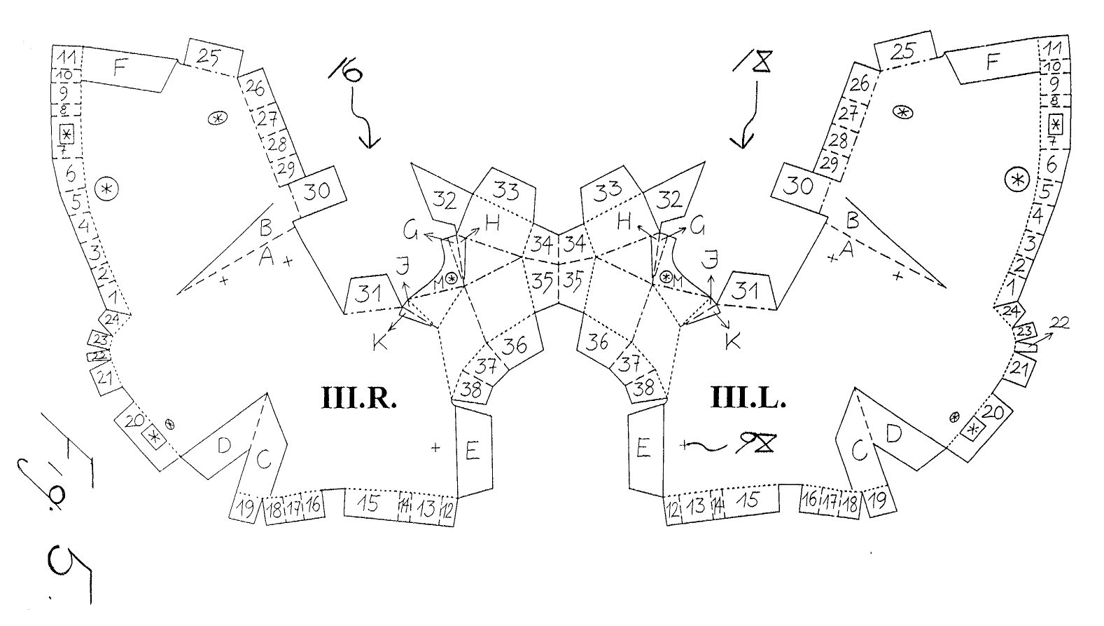

Glue the unmarked face of each of surfaces “1-15” of element “III.R.” 16 to the marked face of each of surfaces “1-15” of element “IV.,” shown in FIG. 6 at 20. Glue the same surfaces of element “III.L.” 18 in the same way to the left side of element “IV.” 20.

Glue the unmarked face of surface “A” of element “IV.” 20 to the marked face of surface “A” of element “V.,” shown in FIG. 7 at 22. Repeat with the “B” surfaces.

Glue the unmarked face of surface “C” of element “V.” 22 to the marked face of surface “C” of element “IV.” 20. Repeat with the “D” surfaces.

Glue the unmarked face of each of surfaces “16-24” of elements “III.R.” and “III.L.” 16 and 18, respectively, to the marked face of each of the same surfaces of element “V.” 22.

Glue the marked face of surface “30” of element “III.R.” 16 to the marked face of the same surface of element “I.” 12.

Glue the unmarked face of surface “26” of element “III.R.” 16 to the unmarked face of surface “26” of element “II.” 14. Repeat with surfaces “27-29.”

Glue element “III.R.” 16 to the surface of elements “I.” and “II.” 12 and 14, respectively, in the same way.

Glue the unmarked face of surface “35” of element “III.R.” 16 to the marked face of surface “35” of element “I.” 12. Repeat for the left side.

Glue the unmarked face of each of surfaces “34” and “33” of element “III.R.” 16 to the marked face of each of surfaces “34” and “33” of element “I.” 12. Repeat for the left side.

Glue the unmarked face of surface “G” of elements “III.R.” and “III.L.” 16 and 18, respectively, to the marked face of surface “H” of the same elements 16, 18.

Glue the unmarked face of surface “J” of elements “III.R.” and “III.L.” 16 and 18, respectively, to the marked face of surface “K” of the same elements 16, 18.

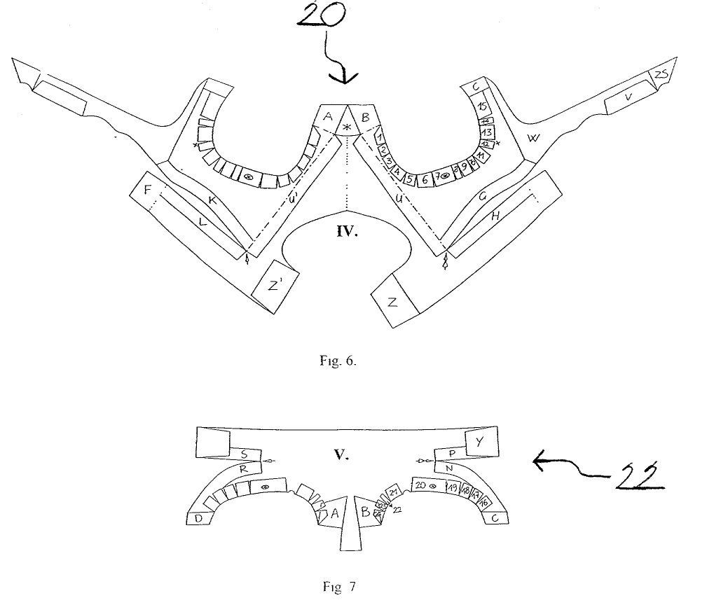

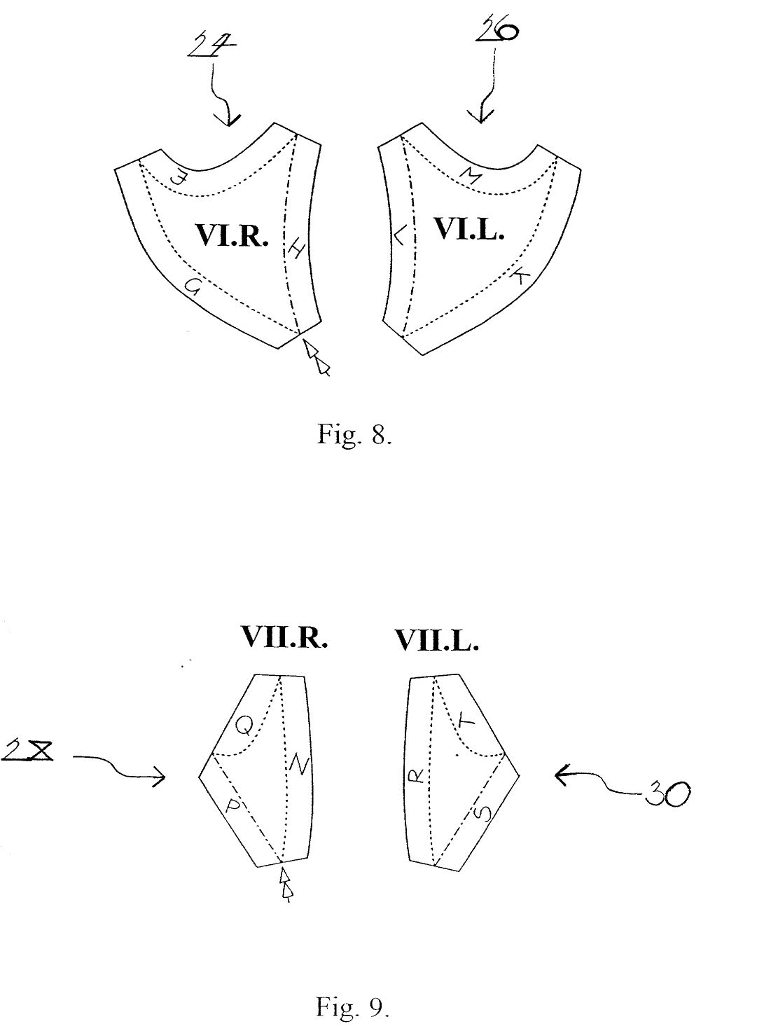

Glue the unmarked face of surface “G” of element “VI.R.,” shown in FIG. 8 at 24, to the marked face of surface “G” of element “IV.” 20. The point of element “VI.R.” 24 marked by a “double arrow” should overlap the point of element “IV.” 20 marked by a “double arrow.” Repeat with the left side with surface “K” of element “VI.L.,” shown in FIG. 8 at 26, and element “IV.” 20.

Glue the unmarked face of surface “E” of element “IV.” 20 to the marked face of surface “E” of element “II.” 14. Repeat with surface “F” on the left side.

Glue the unmarked face of surface “H” of element “VI.R.” 24 to the marked face of surface “H” of element “IV.” 20. Repeat with surface “L” of elements “VI.L.” and “IV.” 26 and 20, respectively.

Glue the unmarked face of surface “N” of element “VII.R.,” shown in FIG. 9 at 28, to the marked face of surface “N” of element “V.” 22. The point of element “VII.R.” marked by a “double arrow” should overlap the point of element “V.” 22 marked by a “double arrow.” Repeat with the left side with surface “R” of element “VII.L.,” shown in FIG. 9 at 30, and element “V.” 22.

Glue the unmarked face of surface P of the element VILR (FIG. 9.) to the marked face of surface P of the element V. (FIG. 7.). Do the same things with the S surfaces of the VILL (FIG. 9.) and V. (FIG. 7. elements on the left side.

Glue the unmarked face of surface A of the element IX.L (fig. II) to the marked face of surface B of the element IX.R (FIG. 11.). Glue the unmarked face of surface C of the element IXR (fig. I) to the marked face of surface C of the same element. Do the same things with the similarly marked surfaces of the IX.L (FIG. 1.) element.

Glue the unmarked face of surfaces 1-8 of the element lX.R (fig,′) to the marked face of surfaces ‘-8’ of same element. Do the same things with the surfaces 1-8 and ‘-8’ of the IX.L (fig. element on the left side.

Glue the unmarked face of surfaces D, E and F of the element IX.R (FIG. 1.) to the marked face of surfaces D, E, and F of the element VIII.R (FIG. 10, Do the same process with the D, E and F surfaces of the IX.L (fig.) and VIILL (FIG. 10.) elements on the left side.

Glue the unmarked face of the entire surface of the element VIII.R (FIG. 10.) to the marked face of surface A of the element l. (FIG. 3. Glue the unmarked face of the entire surface of the element WILL (FIG. 10.) to the marked face of surface B of the element (FIG. 3

Glue the marked face of surfaces W of the elements IX.R (fig. and IV. (FIG. 6.) to each other. Do the same process on the left side.

Glue the marked face of surface Y of the element V. (FIG. 7 to the unmarked face of surface Y of the element IX.R (FIG. 11.). Do the same process on the left side.

Glue the unmarked face of surface G of the element IX.R (FIG. 11 to the marked face of surface G of the element ll. (fig. A). Do the same things with the H surfaces of the IX.L (FIGS. I and 11. (FIG. 4.) elements on the left side.

Glue the unmarked face of surface J of the element VI.R (FIG. 8.) to the marked face of surface of the element IX.R (FIG. 11.). Do the same things with the M surfaces of the VLL (FIG. 8.) and IX.L (FIG. 1) elements on the left side.

Glue the unmarked face of surface Q of the element VILR (FIG. 9.) to the marked face of surface Q of the element IX.R (FIG. 11.). Do the same things with the T surfaces of the VILL (FIG. 9. and ML (FIG. 11.) elements on the left side.

Glue the marked face of surface V of the element W. (FIG. 6.) to the unmarked face of surface V of the element l. (FIG. 3.). Do the same process on the left side.

Glue the marked face of surfaces J and K of the element IX.R (FIG. 11.) to the unmarked face of surfaces F and K′ of same element. Do the same process on the left side.

Glue the unmarked face of surface ZS of the element IV. (FIG. 6. to the unmarked face of surface ZS of the element IX.R (FIG. 11.). Do the same process on the left side.

Glue the unmarked face of surface 25 of the element III.R (FIG. 5. to the marked face of surface 25 of the element IX.R (fig. I). Do the same process on the left side.

Glue the marked face of surface 9-14. of the elements IX.R and IX.L (FIG. 1 to the unmarked face of surface 9-14. of the element l. (FIG. 3,).

Glue the tinmarked face of surface 36., 37. and 38. of the element IILR (FIG. 5.) to the marked face of surface 36., 37. and 38. of the element IX.R (fig.). Do the same process on the left side,

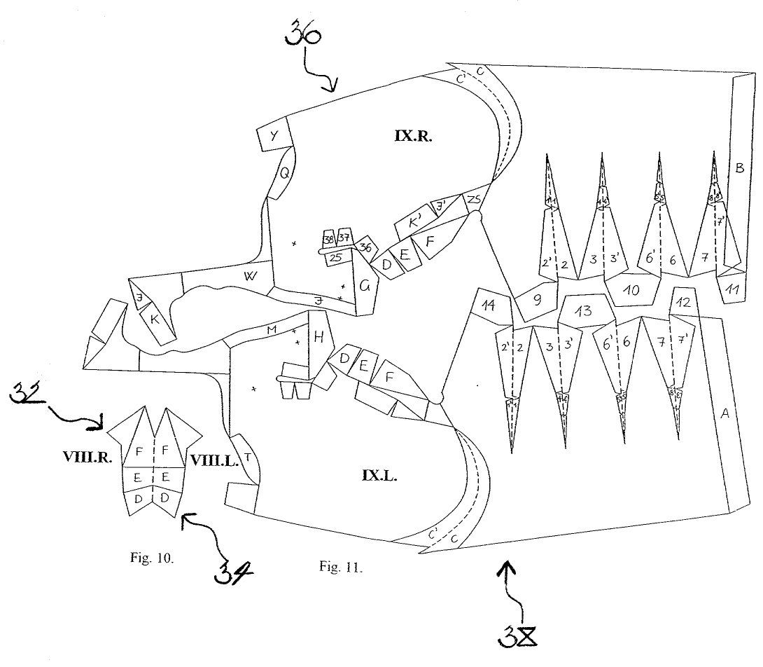

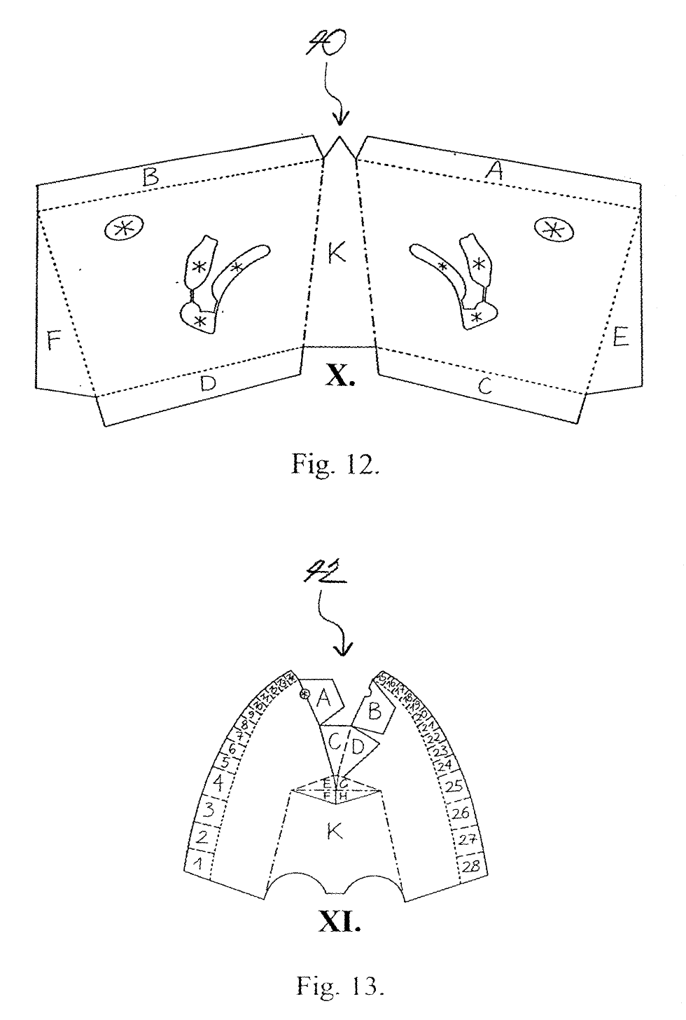

Glue the immarked face of surface C, D and K of the element X (FIG. 12. to the marked face of stirfice C, D and K of the element Il. (FIG. 4. Glue the marked face of surface A and B of the element X. (FIG. 12-.) to the marked face of surface U and U′ of the element IV. (FIG.-6.

Glue the:

unmarked face of surface A with the marked face of surface B;

unmarked face of surface C with the marked face of surface D;

unmarked face of surface E with the marked face of surface F;

unmarked face of surface G with the marked face of surface H of the XI element (FIG. 13.).

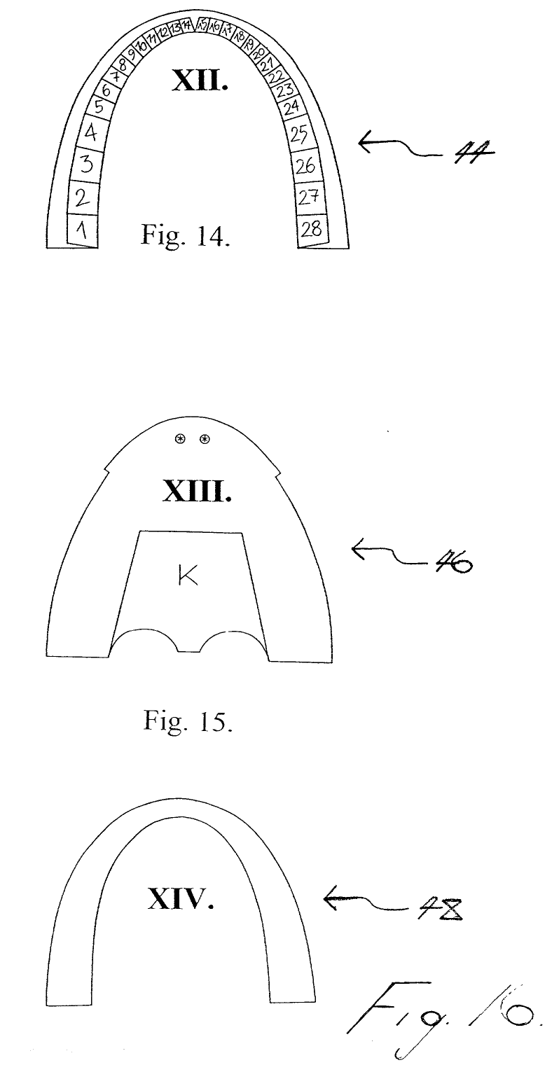

Glue the marked face of surfaces 1-28. of the element XI. (FIG. 13. to the marked face of surfaces -28. of the element XII. (FIG. 14.), Glue the marked face of the element XIV (FIG. 16. to the marked face of the element XIL (fig. XIV.). Glue the marked face of surfaces K of the element XI. (FIG. 13.) to the marked face of surfaces K of the element XHI. (FIG. 15

Put the processed XI-XII-XIII-XIV elements to the place of hard palate and Glue the unmarked face of the surface Z and the marked face of the surface Z′ of the IV. element (FIG. 6.) to each other.

Glue the unmarked face of surface A of the element VII.R (FIG. 9.) to the marked face of surface B of the same element. Do the same things with the C and D surfaces on the left side. Glue the unmarked face of surface E of the element VII.R (FIG. 9.) to the marked face of surface F of the same element.

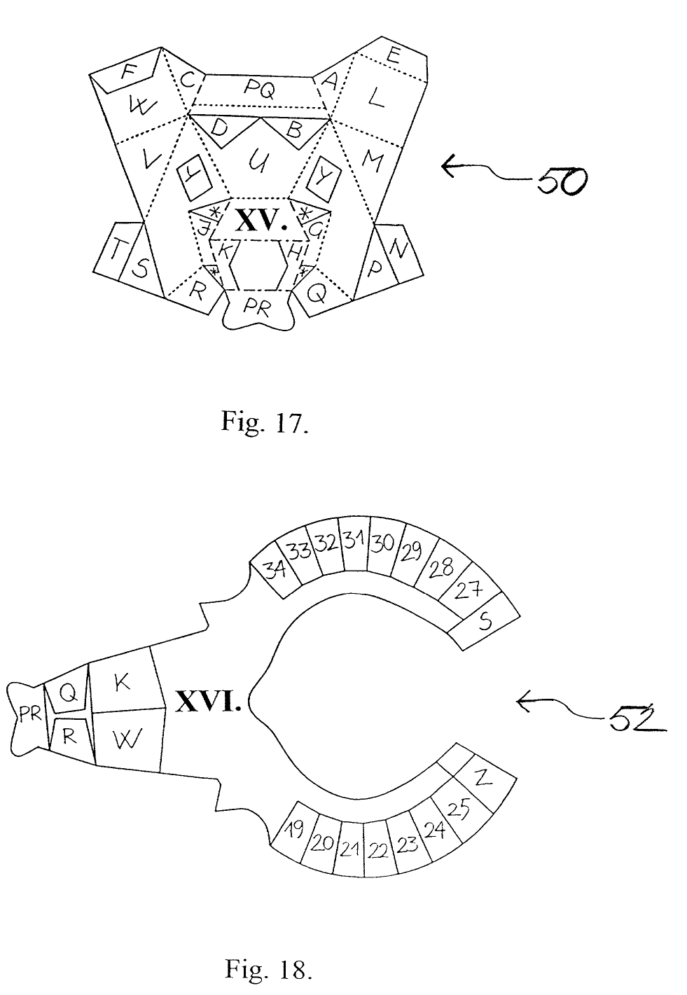

Glue the unmarked face of surface G of the element XV. (FIG. 17.′ to the marked face of surface H of the same element and the unmarked face of surface J to the marked face of surface K.

Glue the unmarked face of surface S of the element XVI. (FIG. 18. to the marked face of surface Z of the same element, so the posterior part of the element forms an opening cone towards the unmarked surface of the paper.

Glue the marked face of surface PR of the element XVI. (FIG. 18.) to the marked face of surface PR of the element XV. (FIG. 17.). Glue the unmarked face of surface Q of the element XV. (FIG. 17.) to the marked face of surface Q of the element X-VI. (FIG. 18.). Do the same process with the R surfaces of the XV. (FIG. 7.) and X-VI. (FIG. 18.) elements on the left side.

Glue the:

unmarked face of surface D with the marked face of surface E;

unmarked face of surface F with the marked face of surface G;

unmarked face of surface Q with the marked face of surface Q′;

unmarked face of surface R with the marked face of surface R′;

unmarked face of surface H with the marked face of surface J;

unmarked face of surface 1-6. With the marked face of surface 1′-6′;

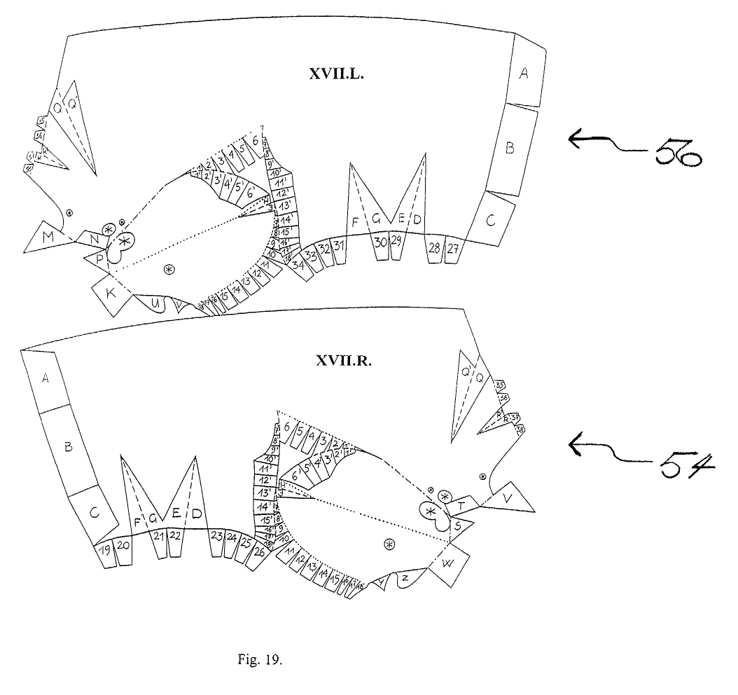

unmarked face of surface 7-18 with the marked face of surface 7′-18′ of the XVH.R element (FIG. 19.).

Do the same process with the XVILL element (FIG. 19.) on the left side.

Glue the unmarked face of surface V of the element XVILR (FIG. 19.) to the marked face of surface V of the element X-V. (FIG. 17.).

Glue the unmarked face of surface T of the element XV. (FIG. 17.) to the marked face of surface T of the element XVILR (FIG. 19.).

Glue the unmarked face of surface S of the element XVILR (FIG. 19.) to the marked face of surface S of the element XV. (FIG. 17.).

Glue the unmarked face of surface R of the element XV. (FIG. 17.) to the marked face of surface R of the element XVI. (FIG. 18.).

Glue the unmarked face of surface W of the element XVILR (FIG. 19.) to the marked face of surface W of the element XVI. (FIG. 18.).

Glue the unmarked face of surfaces 19-26. of the element XVILR (FIG. 19.) to the marked face of surfaces 19-26. of the element XVI. (FIG. 18.). (Glue the surface 26 on the surface S!)

Glue the unmarked face of surfaces M of the element XVILL (FIG. 19.) to the marked face of surfaces M of the element XV. (FIG. 17.).

Glue the marked face of surfaces N of the element XVILL (FIG. 19.) to the unmarked face of surfaces N of the element XV. (FIG. 17.).

Glue the unmarked face of surfaces P of the element XVILL (FIG. 19.) to the marked face of surfaces P of the element XV. (FIG. 17.).

Glue the unmarked face of surfaces Q of the element XV (FIG. 17.) to the marked face of surfaces Q of the element XVI (FIG. 18.).

Glue the unmarked face of surfaces K of the element XVILL (FIG. 19.) to the marked face of surfaces K of the element XVI (FIG. 18.).

Glue the unmarked face of surfaces 19-26 of the element XVILL (FIG. 19.) to the marked face of surfaces 19-26. of the element XVI (FIG. 18.). (Glue the surface 26 on the surface S!)

Glue the unmarked face of surfaces C, D and A of the element XVILL (FIG. 19.) to the marked face of surfaces C, D and A of the element XVILR (FIG. 19.).

Place the prepared XV-XVI-XVILR-XVILL element into the posterior concavity of the neurocranium and Glue the corresponding surfaces (rim, foramen magnum) to each other. Glue the marked face of surface PQ of the element XV (FIG. 17.) to the marked face of upper surface of the element ll. (FIG. 4.). Glue the marked face of surfaces L and W of the element XV. (FIG. 17.) to the unmarked face of upper surface of the element ll (FIG. 4.).

Glue the:

unmarked face of surface B with the marked face of surface A;

unmarked face of surface C with the marked face of surface D;

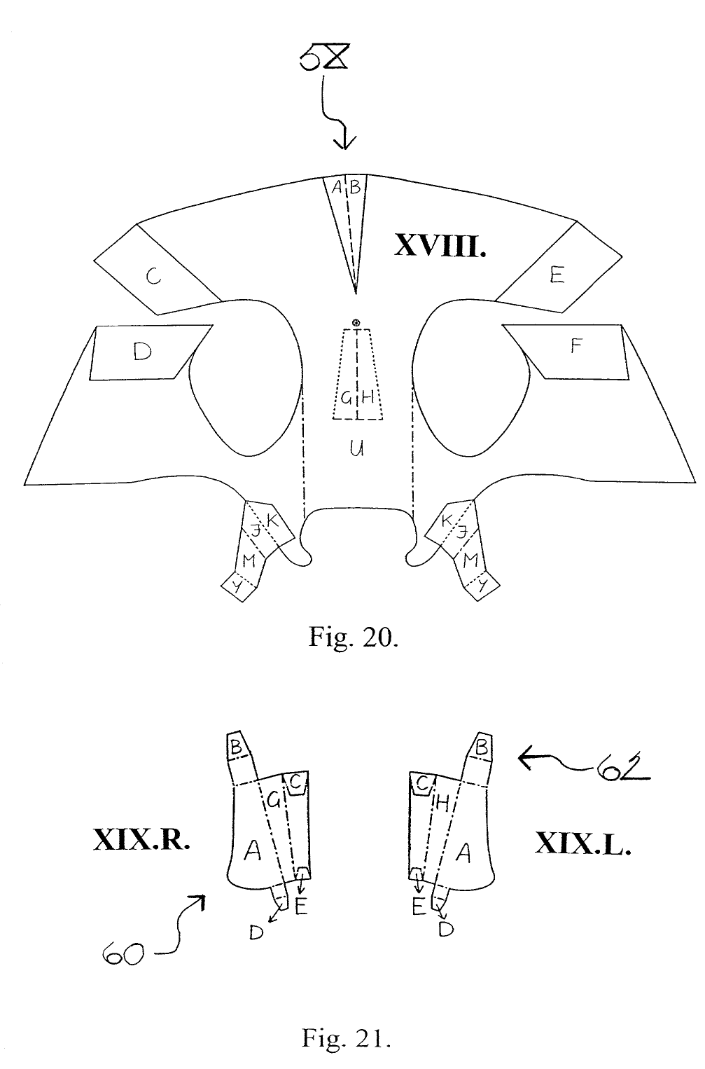

unmarked face of surface E with the marked face of surface F of the XVIII element (FIG. 20.).

Glue the marked face of surfaces J to the marked face of surfaces K of the element XVIII (FIG. 20.) on both sides. Place the processed XVIH element (FIG. 20.) into the anterior concavity of the neurocranium and Glue the corresponding surfaces (rim) to each other.

Glue the unmarked face of surface Y of the element XVIII (FIG. 20.) to the unmarked face of surface Y of the element XV (FIG. 17.).

Glue the marked face of surface A of the element XIX.R (FIG. 2L) to the marked face of surface A of the element XIX.L (FIG. 21.).

Glue the:

unmarked face of surface B with the marked face of surface C;

unmarked face of surface D with the marked face of surface E of the XIX.R element (FIG. 20.).

Do the same process with the XIX.L element (FIG. 21.).

Glue the unmarked face of surfaces G and H of the element XVIII (FIG. 20.) to the unmarked face of surfaces G and H of the elements Y.IX.R and XIX.L (FIG. 21.).

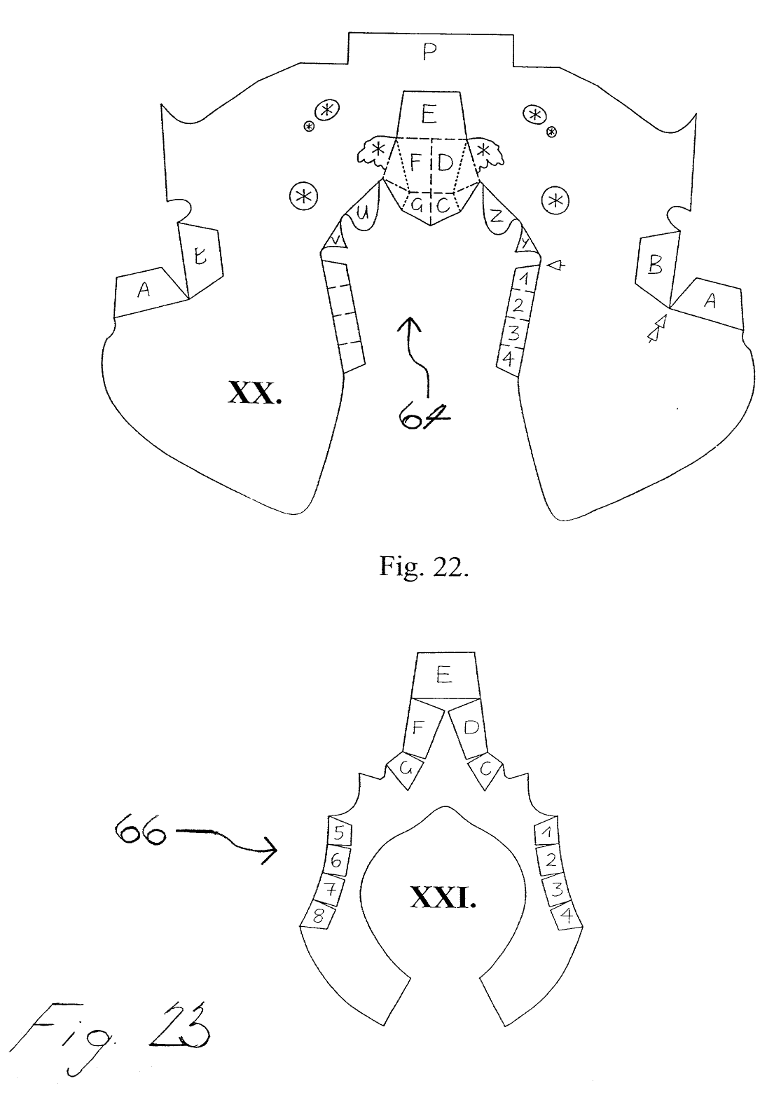

Glue the unmarked face of surface A with the marked face of surface B of the XX element (FIG. 22.

Glue the marked face of surface E of the XX element (FIG. 22.) to the unmarked face of surface E of the XXI. element (FIG. 23.). Glue the unmarked face of surfaces F, D, G, C and I-8 of the element XX (FIG. 22.) to the marked face of similarly marked surfaces of the XXI element (FIG. 23.

Glue the marked surface of the XX-XXI elements and Glue it to the external skull base in the way the cut oval and small round shaped windows marked by stars on the element XX (FIG. 22.) fit to the same ones on the skull base (element l.).

Glue the marked face of surfaces Z and Y of the element Xx (FIG. 22.) to the marked face of surfaces Z and Y of the element XVILR (FIG. 19.), Do the same process with the U and V surfaces of the XX (FIG. 22.) and XVILL (FIG. 19.) elements on the left side.

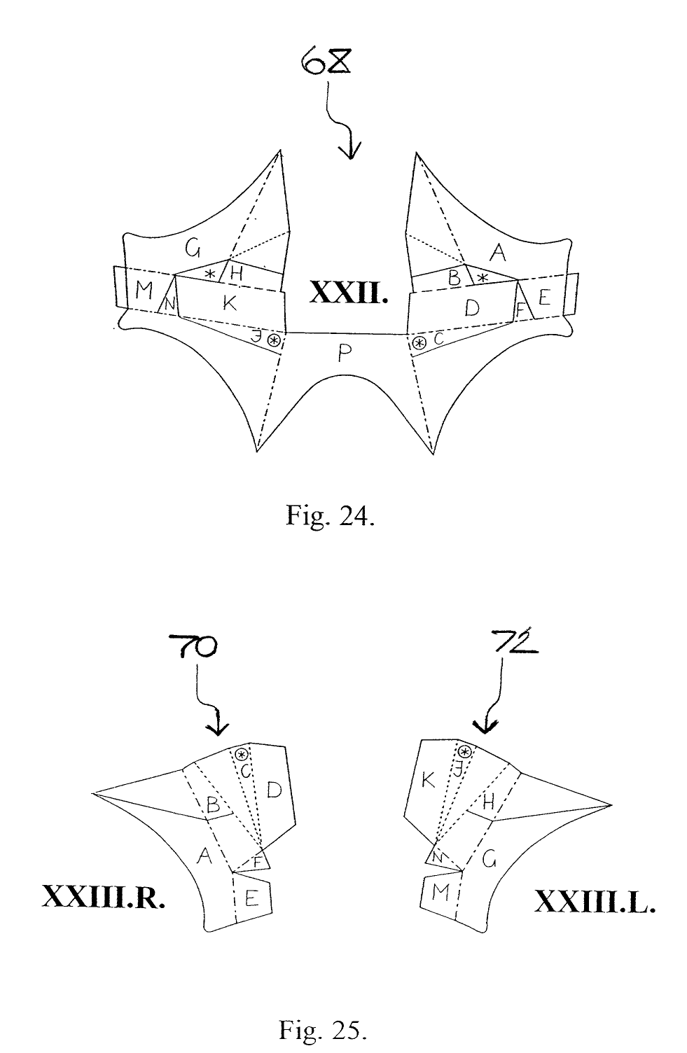

Glue the unmarked face of surfaces C and D and the marked face of surfaces E and F of the element XXIII.R (FIG. 25.) to the marked face of surfaces C, D, E and F of the element XXII (FIG. 24.

Glue the marked face of surfaces A and B of the element XXIH.R (FIG. 25.) to the marked face of surfaces A and B of the element XXII (FIG. 24.).

Glue the unmarked face of surfaces J and K and the marked face of surfaces M and N of the element XXIH.L (FIG. 25.) to the marked face of surfaces J, K, M and N of the element XXII (FIG. 24˜.

Glue the marked face of surfaces G and H of the element XMILL (FIG. 25.) to the marked face of surfaces G and H of the element XXII (FIG. 24.).

Glue the marked face of surface P of the element XXII (FIG. 24.) to the unmarked face of surface P of the element XX. on the skull base (FIG. 22.). Glue the unmarked face of surfaces D, F and E of the element XXII (FIG. 24.) to the unmarked face of inner surface of the element ll. (FIG. 4.). Do the same process with the K, N and M surfaces of the element Y-Xll (FIG. 24.) and the unmarked face of the element II (FIG. 4.) on the left side.

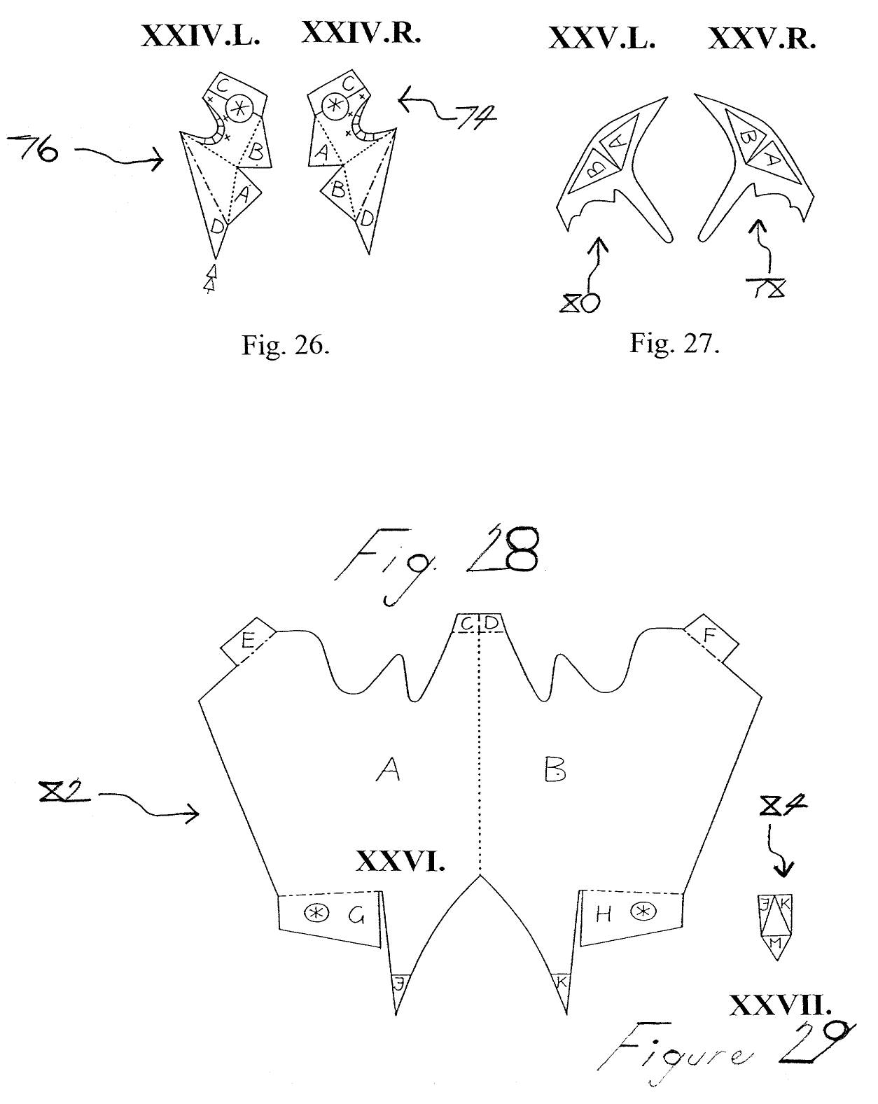

Glue the marked face of surfaces A and B of the element XX-V.R (FIG. 27, to the unmarked face of surfaces A and B of the element XYdV.R (FIG. 26.). Do the same process with A and B surfaces of the elements XXV.L (FIG. 27.) and XXIV.L (FIG. 26.) on the left side of the skull.

Glue the marked face of surfaces C and D of the element XXIVA (FIG. 26.) to the external skull base. The following points should be overlapped:

the point of the skull base marked by arrowhead with the point of the element XXIVA (FIG. 26.) marked by the same way;

the point of the skull base marked by double arrowhead with the point of the element YXIV.R (FIG. 26.) marked by the same way;

the round shaped window of the skull base with the same item of the element XXIVA (FIG. 26.). Do the same process with the similar items of the skull base and the element XXIV.L (FIG. 26.) on the left side.

Glue the marked face of surfaces A and B of the element XXVI (FIG. 28.) to each other. Glue the marked face of surfaces J and K of the element XXVI (FIG. 28.) to the unmarked face' of surfaces J and K of the element XXVII (FIG. 29.).

Remove the palate from the skull and put elements “XXVI.” and “XXVII.” 82 and 84, respectively, into the nasal cavity. Surfaces “C,” “D,” “E,” “F,” “G,” and “H” are contacted to the inner wall of the nasal cavity, and element “XXVII.” 84 is located on the external surface of the skull-base behind the nasal cavity. After application of the nasal septum, put back the hard palate.

Preferably, before each gluing step, the user allows sufficient time for the previous bond to hold securely. Also, a strong, fast-drying glue is used. And, completion of each step is immediately noted to assist in assembling the model in the proper order. Furthermore, the more precision that is attained in pasting together the different elements the more aesthetically pleasing the model will be.

In addition, by paying close attention to small details, the paper-skull-model system 10 can make the difficult parts of the complicated human skull easy to understand. Moreover, a user can try to find the anatomical structures on the assembled model that are listed in a “structure legend,” for example. Plus, the user, by taking his or her time assembling the model, can learn anatomy at least as much as or more than he or she can from the assembled model itself and have fun doing it.

The paper-skull-model system 10 can be used for satisfactorily studying the anatomy and composition of the human skull; permits parts of the skull represented by respective pieces of the model to be assembled by hand such that the complex anatomical structure of the skull and complicated anatomical features thereof can be understood during assembly of the model; is suitable for demonstrating the most difficult parts of the bones of the skull; is relatively inexpensive to manufacture and, consequently, affordable for many medical students and others interested in human anatomy; and is fun and entertaining to assemble. Also, users of the paper-skull-model system 10 do not get lost during use thereof with complicated and difficult-to-understand anatomical details of the skull, and, thus, the paper-skull-model system 10 makes learning the anatomy of the skull relatively easy.

The paper-skull-model system 10 simplifies the complicated structure of the human skull and emphasizes the clinically important details thereof. The paper-skull-model system 10 unburdens understanding of the complex bony items of the skull in anatomical studies.

This invention has been described in an illustrative manner. It is to be understood that the terminology that has been used is intended to be in the nature of words of description rather than of limitation. Many modifications and variations of the present invention are possible in light of the above teachings. Therefore, the present invention may be practiced other than as specifically described.

We claim:

1. A paper-skull-model system for constructing a model of the human skull comprising:
a plurality of elements representing various parts of the skull and adapted to be attached to each other, each of said plurality of elements adapted to be physically manipulated by a user of said system and having at least one marking disposed thereon; and
a set of instructions to instruct the user how to physically manipulate each of said plurality of elements with respect to each of said at least one marking and attach said plurality of elements together to construct the skull.

2. The paper-skull-model system as recited in claim 1, wherein said plurality of elements are made of paper.

3. The paper-skull-model system as recited in claim 1, wherein said plurality of elements are made of cardboard.

4. The paper-skull-model system as recited in claim 1, wherein said plurality of elements are made of plastic.

5. The paper-skull-model system as recited in claim 1, wherein said plurality of elements are made of metal.

6. The paper-skull-model system as recited in claim 1, wherein said plurality of elements are attached to each other by glue.

7. The paper-skull-model system as recited in claim 1, wherein the model is constructed by hand.

8. The paper-skull-model system as recited in claim 1, wherein said at least one marking is disposed on only one side of each of said plurality of elements.

9. The paper-skull-model system as recited in claim 1, wherein said plurality of elements represent the orbits and facial cranium, zygomatic arch, neurocranium, nasal septum and hard palate, middle and posterior cranial fossa, anterior cranial fossa, external skull base, pterygoid and styloid processes, and nasal cavity of the skull.

10. The paper-skull-model system as recited in claim 9, wherein said plurality of elements include 37 elements.

11. The paper-skull-model system as recited in claim 1, wherein said at least one marking includes a marking to identify each of said plurality of elements.

12. The paper-skull-model system as recited in claim 1, wherein said at least one marking includes a marking to identify a particular surface that is to be attached to a corresponding surface of at least another of said plurality of elements.

13. The paper-skull-model system as recited in claim 1, wherein said at least one marking includes a marking to identify an area to be removed.

14. The paper-skull-model system as recited in claim 1, wherein said at least one marking includes a marking to identify a point to be pierced.

15. The paper-skull-model system as recited in claim 1, wherein said at least one marking includes a marking to identify a line to be cut.

16. The paper-skull-model system as recited in claim 8, wherein said at least one marking includes a marking to identify a folding line that defines a surface on either side thereof to be folded toward the marked side of said element.

17. The paper-skull-model system as recited in claim 8, wherein said at least one marking includes a marking to identify a folding line that defines a surface on either side thereof to be folded toward the unmarked side of said element.

18. The paper-skull-model system as recited in claim 1, wherein said at least one marking includes a marking to identify a border of said element.

19. The paper-skull-model system as recited in claim 1, wherein said each of said plurality of elements is adapted to be at least one of bent, cut, folded, and pierced.

20. The paper-skull-model system as recited in claim 1, wherein said
